(19) United States
(12) Patent Application Publication
(10) Pub. No.: US 2018/0077851 A1
(43) Pub. Date: Mar. 22, 2018

(54) OBSTACLE DETECTION WARNING SYSTEM

(71) Applicant: CNH Industrial America LLC, New Holland, PA (US)

(72) Inventor: Michael C. Hatton, Washington, IL (US)

(73) Assignee: CNH Industrial America LLC, New Holland, PA (US)

(21) Appl. No.: 15/267,958

(22) Filed: Sep. 16, 2016

(51) Int. Cl. A01B 76/00; A01B 35/32; G01S 15/93; G01S 17/93

(52) U.S. Cl. CPC A01B 76/00; G01S 17/936; G01S 15/931; A01B 35/32

(57) ABSTRACT

An obstacle warning system having sensors solely positioned adjacent the lateral extremities of an implement towed by a tractor for determining the presence of an object within a given distance. An alarm generator positioned within an operator cab for the tractor provides a visual or audible signal indicating the presence of an obstacle in the forward path of the lateral extremities of the implement.

### BACKGROUND OF THE INVENTION

### 1. Field of the Invention

The present invention relates to agricultural implements and more specifically to systems for determining whether such implements are encountering obstacles.

### 2. Description of the Related Art

Towed agricultural implements in the form of planter/seeders, tillage implements and others have increasingly longer lateral extremities. These implements are towed through a field behind a tractor guided by an operator who is mainly concentrating on navigating the tractor in a predetermined pattern. As such, the operator has limited visibility at the extremities of the laterally oriented implement. In an attempt to increase in efficiency with a given plot of land, farmers are attempting to push the edge of their fields closer to existing fence lines and woodlands thereby increasing the likelihood of a collision between the limits of the implement and a fence post, tree, rock or other obstacle.

Some approaches have been made to determine presence of objects in the forward path of an implement, such as in automated lawn mowing equipment. However, these are extraordinarily complicated and expensive owing to the multiplicity of the sensors and the complexity of the algorithms in analyzing and providing a meaningful determination from the signals.

Accordingly, it is an object of the present invention to simplify the obstacle detection in a towed implement and thus make the process more economical.

### SUMMARY OF THE INVENTION

The present invention seeks to greatly simplify the process of obstacle detection and appropriate signals in an agricultural implement.

In one form, the invention is an obstacle warning system for ground movement implement towed by a tractor and having laterally extremities beyond the width of the tractor. The system includes sensors solely positioned adjacent the lateral extremities of the towed implement and pointed in at least in the forward direction of travel for the towed implement for generating a signal indicating the local presence of an obstacle within a predetermined distance. An indicator on the tractor is configured to receive the signal and provide at least one of a visual and aural warning.

In another form, the invention is a towed implement having a tool bar extending laterally relative to the direction of movement and having extremities. Ground support wheels provide guided movement in the ground drive direction. Sensors are solely positioned on the tool bar adjacent its lateral extremities and are pointed in at least in the direction of travel for the towed implement for generating a signal indicating the local presence of an obstacle within a predetermined distance. An indicator is configured to receive the signal and provide at least one of a visual and aural warning.

One benefit of the present invention is an effective obstacle warning system to provide a tractor operator, an indication of an impending obstacle.

Another advantage is that the simplicity of the device allows the system to be scalable to a small agricultural operation.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is illustrates an agricultural implement, being pulled by a tractor, with which an obstacle detection system embodying the present invention may be used; and,

FIG. 2 is a schematic view of the agricultural implement of FIG. 1 showing the obstacle detection system interconnections.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

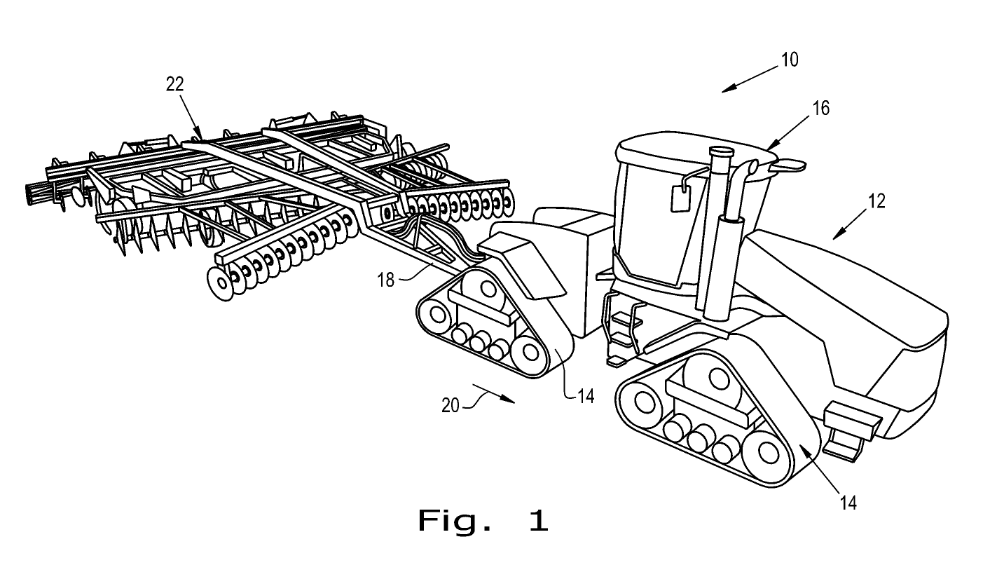

FIG. 1 illustrates an agricultural implement 10, including a tractor 12 driven by a plurality of ground tracks 14 for movement across a field. Although shown with ground tracks 14, the tractor may also be utilized with wheel assemblies. The tractor 12 has a power unit and power transmission to drive the track wheel assemblies and for other functions. These are not shown to simplify the understanding of the present invention. The tractor 12 includes an operator cab 16 in which the operator navigates the tractor through a field to tow a tillage implement 22 by means of a tow frame 18 in a forward direction 20. It is typical for the tillage implement 22 to be significantly wider in a lateral dimension than the tractor 12. This makes it difficult for a operator in cab 16 to guide the tractor 12 properly while observing any potential obstacle or interference toward the extremities of the tillage implement 22. Although implement 22 is shown as a tillage implement, it should be apparent to those skilled in the art that other implements may be employed, such as a seeder, planter or fertilizer applicator. In all cases, when the tractor operator is seeking to increase efficiency by coming close to the borders of the field, the incidence of encountering an obstacle increases.

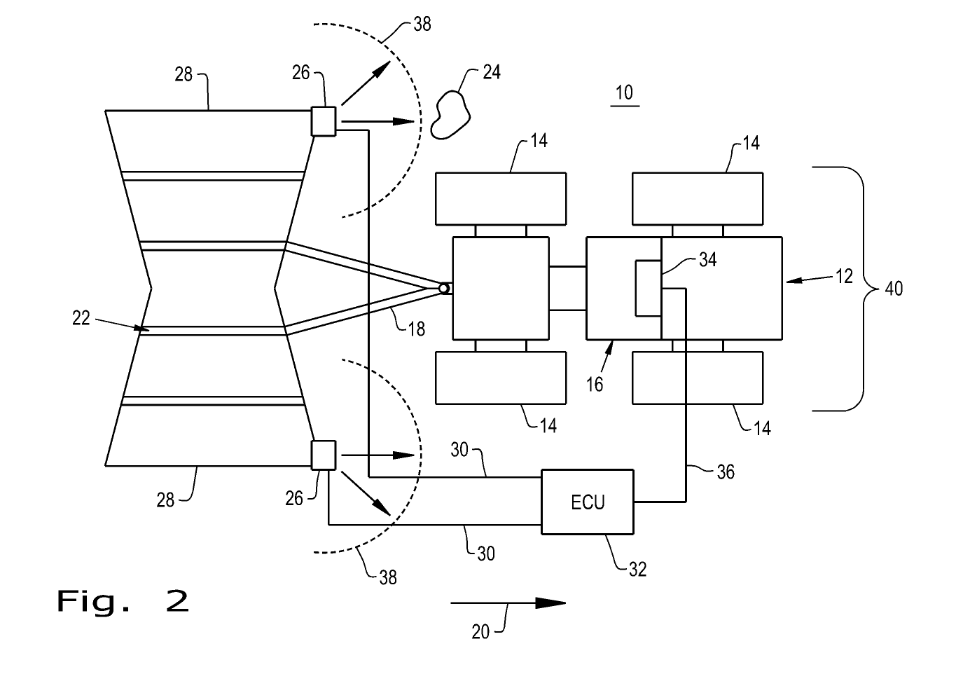

In accordance with the present invention, the obstacle detection warning system illustrated in FIG. 2 is provided to give an operator an alert. As shown in FIG. 2, an obstacle 24 may be positioned at a location in a field and is not always readily ascertainable as the operator passes by. Since the lateral extremities 28 of implement 22 project significantly beyond the width 40 of tractor 12, the operator no longer has a view of the obstacle 24 owing to the fact that the implement 22 is so far behind the operator. For detection, sensors 26 are placed solely adjacent the lateral extremities of implement 22 and are shown as connected to an ECU 30 by lines 30. An alarm generator 34 is positioned in operator cab 16 and is shown as connected to ECU 32 by a line 36. Sensors 26 may be either ultrasonic or infrared and take the form of a sensor that can actively look for an obstacle by sending out a signal and detecting an echo. The sensors 26 can then be programmed to have a detection range 38 that is adjacent the extremities 28 of implement 22 and at least pointed in a forward direction. When the sensor 26 is pulled within the detection range 38 towards obstacle 24, it then sends a signal to ECU 32 which in turn is fed to the alarm generator 34 in cab 16. The alarm generator 34 may be audible or it may be visual and it may be provided in proportion with a frequency and/or intensity directly proportional to the distance to obstacle 24.

As a result, the operator in cab 16 may focus all attention in a forward direction to properly navigate the agricultural implement as efficiently and close to the field boundaries as possible. If an obstacle such as 24 is detected, an alarm is sounded prior to collision to provide adequate warning to the operator to stop or take evasive action. By utilizing sensors only adjacent the extremities 28 of implement 22, the system can be greatly simplified. Furthermore, the use of audible signals and visual signals provides a simplified and sensory appropriate alarm, so that the operator intuitively knows to stop the tractor 12 or take evasive action.

While the sensors 26 and alarm generator 34 have been shown as connected by appropriate lines, it should be apparent to those skilled in the art that the interconnection between these devices and the ECU 32 may be in a wireless or blue tooth interconnection. The ECU 32 is illustrated as a separate ECU, but the function of the obstacle alert may be incorporated in an existing chassis ECU or engine ECU, as appropriate.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An obstacle warning system for a ground movement implement towed by a tractor and having lateral extremities beyond the width of the tractor, said system comprising:
a sensor solely positioned adjacent at least one of the lateral extremities of said towed implement and pointed at least in the forward direction of travel for said implement for generating a signal indicating the local presence of an obstacle within a predetermined distance; and,
an alarm generator on the tractor configured to receive said signal and provide at least one of a visual and aural warning.

2. The obstacle warning system as claimed in claim 1, wherein said sensor is one of an infrared and ultrasonic sensor.

3. The obstacle warning system as claimed in claim 2, wherein said sensors are active sensors.

4. The obstacle warning system as claimed in claim 2, wherein said alarm generator produces a signal of at least one of increasing intensity and frequency in direct proportion to the distance from the obstacle.

5. The obstacle warning system as claimed in claim 1, having sensors on both lateral extremities of the implement.

6. The obstacle warning system as claimed in claim 1, wherein the tractor has an operator cab and said alarm generator is positioned within the operator cab.

7. An agricultural implement comprising:
a tractor;
a towed implement interconnected with said tractor and having a lateral dimension with extremities beyond the width of the tractor;
ground support wheels for guiding the implement across the ground;
a sensor solely positioned adjacent at least one of the lateral extremities of the towed implement and pointed at least in the forward direction of travel for the towed implement for generating a signal indicating the local presence of an obstacle within a predetermined distance; and,
an alarm generator on the tractor configured to receive said signal and provide at least one of a visual and aural warning.

8. The agricultural implement as claimed in claim 7, wherein said sensor is one of an infrared and ultrasonic sensor.

9. The agricultural implement as claimed in claim 8, wherein said sensor is an active sensor.

10. The agricultural implement as claimed in claim 8, wherein said alarm generator produces a signal of at least one of increasing intensity and frequency in direct proportion to the distance from the obstacle.

11. The agricultural implement as claimed in claim 7, having a sensor at both lateral extremities of said implement.

12. The agricultural implement as claimed in claim 1, wherein said tractor has an operator cab and said alarm generator is positioned within said cab.

13. The agricultural implement as claimed in claim 6, wherein said towed implement is a tillage implement.
